(19) United States
(12) Patent Application Publication
(10) Pub. No.: US 2008/0116134 A1
(43) Pub. Date: May 22, 2008

(54) Brine-Conserving Nanofiltration Water Softener System

(76) Inventor: Peter S. Cartwright, Bloomington, MN (US)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 10/587,955

(22) PCT Filed: Jan. 28, 2005
(86) PCT No.: PCT/US05/02537

§ 371 Date: Jul. 31, 2006

Related U.S. Application Data
(60) Provisional application No. 60/540,396, filed on Jan. 30, 2004.

(51) Int. Cl. C02F 1/44

(52) U.S. Cl. 210/637; 210/670; 210/744

(57) ABSTRACT

A brine recycling apparatus and process form a part of a water softening system (10). The water softening system (10) has a brine tank (43) for receiving brine solution that has passed through a softening tank (19) of the softening system (10) to remove hardness ions adsorbed on resin regenerating particles in the softening tank (19). The brine solution in the brine tank (43) is forced through a filter such as a nanofilter (25) that allows a much higher proportion of the brine ions to pass than the hardness ions. The liquid passing through the filter (25) is returned to the brine tank (43). The liquid that does not pass through the filter (25) may be directed to a drain. A preferred system uses a pump (51) to force the brine solution through the filter (25).

This is an international application filed under 35 U.S.C. §363 claiming priority under 35 U.S.C. §119 (e) (1), of provisional application Ser. No. 60/540,396, having a filing date of Jan. 30, 2004.

### FIELD OF THE INVENTION

The present invention relates to water softening systems. In particular, the present invention relates to a water softening system having a filtration system that separates hardness ions from brine so that the brine can be recycled instead of being discharged with the hardness ions.

### BACKGROUND OF THE INVENTION

Among industrialized nations of the world, there is a growing concern for, and emphasis on, environmentally responsible practices. For example, more and more governments and communities are interested in minimizing the kinds and quantities of chemicals that are deposited into water systems, including wastewater systems. A common form of wastewater pollution is the brine solution discharged into sewers or septic systems during typical regeneration processes of water softeners.

For the last fifty years or so, water softening has become widely used in those regions where water supplies contain high concentrations of calcium and magnesium, and are therefore considered “hard”. Utilizing a sodium ion exchange process, resin-based water softeners are installed on water lines, particularly those leading into residences, to soften most if not all of the water used inside such homes. As a water supply passes through ion exchange resins inside a water softener, the calcium and magnesium are removed from the water supply.

Periodically, these ion exchange resins must be regenerated. Typically this regeneration is accomplished utilizing a brine solution such as sodium chloride. In a typical regeneration process, the brine solution is slowly pumped through the resin bed. Through a chemical exchange process, the calcium and magnesium ions which were adsorbed onto the resin are stripped off and replaced with sodium ions. At the conclusion of this process, the “spent” brine solution containing both the hardness ions and the brine is discharged into the sewer or septic system. This discharge has serious long-term effects on the environment, as the brine salinity, total dissolved solids, and/or chloride concentrations are depleting the planet's fresh water supplies.

Presently, because this pollution problem has defied resolution by economically acceptable means, some communities are resorting to banning water softening in homes. For example, in December 2002, a “Salinity Summit Meeting”, held to review the water standards for the Colorado River and to discuss plans for salinity control, was attended by over 125 participants from 13 states and the District of Columbia. In 1999, because many of its municipalities were in danger of violating waste discharge permits or water reclamation permits, the State of California reversed its policy prohibiting cities from banning water softeners. Scientific studies such as that conducted by Santa Clarita, Calif. are finding that brine solution discharged from water softeners is a significant source of water pollution. This finding supports prohibitions of, or restrictions on, present, commercially available water softening systems. Consequently, removing the salts from the spent brine solution before the solution is discharged has become an immediate and real concern of communities that want soft water and of water softener manufacturers.

### SUMMARY OF THE INVENTION

The present invention relates to an apparatus and a process to separate hardness ions from brine solution in a way to allow most of the brine solution to be reclaimed, thereby reducing the discharge of brine into the environment.

Nanofiltration (NF) is a pressure driven, membrane separation technology that separates ionic solute from water supplies based on the ionic strength of the solute. Preferred embodiments of the present invention include a pump that supplies the force required to effect the separation and the feeding a brine solution or feed stream into a housing containing a nanofilter membrane element.

In the NF process, multivalent salts are rejected to a higher degree than monovalent salts. Thus, NF used as part of a water softener system can be used to selectively remove the multivalent hardness ions from a brine solution and direct them to a drain while monovalent salts that make up the brine solution are recycled to a water softener brine tank. With the present invention, approximately 90% or more of the brine solution that typically is discharged into a drain can be recovered and recycled, thereby minimizing water pollution as well as the cost of water softener salt from which brine solution is prepared.

The overall operation of the system can be described as follows: When the softener goes into regeneration, during the brine/slow rinse cycle, a valve, modified accordingly, directs the effluent from this cycle back into the brine tank. During the fast rinse cycle, the effluent may or may not be directed to the brine tank, depending on the salinity of this stream. While the softener is in service, the NF system will operate over at least an eight-hour period to slowly process the contents of the brine tank, removing and discharging hardness ions and recycling brine solution.

To incorporate the NF system into a softener, the following modifications will be required: The softener valve must direct the effluent from the brine/slow rinse cycle back to the brine tank. The softener valve may direct some or all of the effluent form the fast rinse cycle back to the brine tank. This decision will be based on a predetermined degree of salinity of this solution. To accommodate this additional brine solution, the brine tank can be increased from the typical capacity of approximate 30 gallons to approximately 60 gallons. The water softener valve, during the “brining” and “slow rinse” (flush) cycles, directs the effluent (discharge stream) back to the brine tank, rather than to the drain.

The invention is an improved process and apparatus for regenerating a water softening system of the type that removes multivalent (hardness) ions from water. The improvement reclaims brine solution carrying the hardness ions.

The water softening system includes a softening tank through which the water to be softened passes from an upstream to a downstream end; a brine tank for holding a monovalent regenerating salt solution; a first diverter valve connected between the bottom of the brine tank and the upstream end of the softening tank; a nanofilter having upstream and downstream sides which permits selective passage of monovalent ions and; a second diverter valve linking the downstream end of the softening tank selectively to the upstream side of the nanofilter; and, a connection between the downstream side of the nanofilter and the brine tank.

The improved regeneration process comprises the step of first conventionally operating the first diverter valve to pass brine solution from the brine tank through the softening tank of the water softening system and operating the second diverter valve to direct liquid from the downstream end of the softening tank to the brine tank.

While brine percolates through the softening tank and typically for a time thereafter, unmodified fluid from the brine tank is directed to the nanofilter. The term “unmodified” in this context refers to brine solution that has not been subjected to pH balancing or other chemical treatment before passing to the nanofilter.

Liquid which has passed through the NF membrane is directed to the brine tank. Liquid which has not passed through the NF membrane is directed to a drain.

Preferably, the water softening system includes a pump which receives the brine solution from the brine tank, and supplies the brine solution to the nanofilter. The pump is powered concurrently with operating the second diverter valve to direct liquid from the downstream end of the softening tank to the brine tank and perhaps after that time interval as well. A throttling valve maintains a relatively high pressure on the upstream side of the nanofilter so that a substantial volume of liquid is forced through the nanofilter.

Although the preferred embodiments of the NF water treatment system for water softeners have been described herein, it should be recognized that numerous changes and variations can be made to these embodiments, which changes and variations are still within the scope and spirit of the present invention. The present invention should not be unduly limited by the illustrative embodiments and examples set forth herein for exemplary purposes. Rather, the scope of the present invention is to be defined by the claims.

### BRIEF DESCRIPTION OF THE DRAWING

FIG. 1 is a diagram of a water softener system including a NF water treatment system.

### DETAILED DESCRIPTION OF THE INVENTION

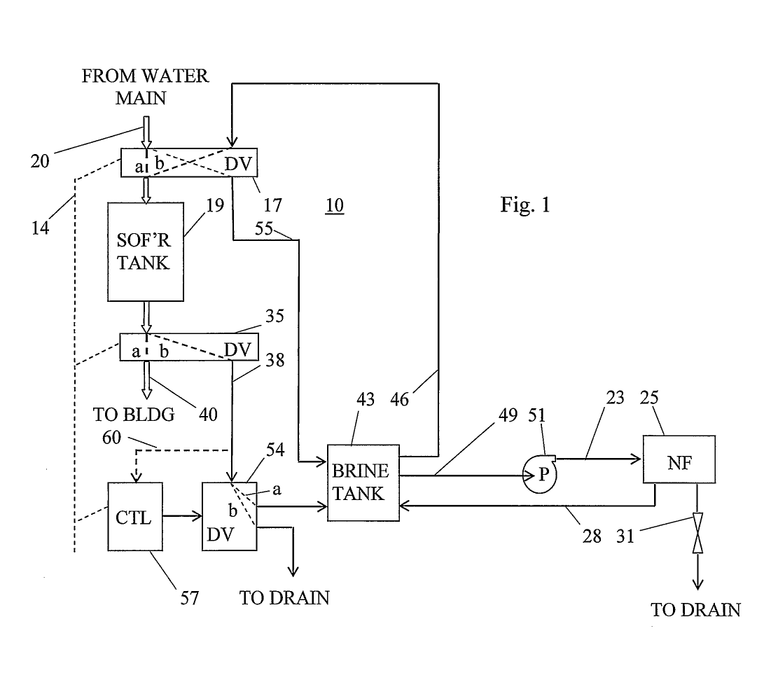

Referring to FIG. 1, a water softening system 10 includes a connection to a source of water to be softened such as water main 20. Water from main 20 is directed to a softener tank 19, softened by flowing through softener tank 19, and supplied to a user such as a building through a plumbing connector 40.

System 10 operates in either a normal mode or a regeneration mode. The operating mode is determined by settings of first and second diverter valves 17 and 35. The settings of valves 17 and 35 are controlled by a linkage 14. In typical commercial systems, valves 17 and 35 are combined in a single physical unit with functionality as shown.

Diverter valves 17 and 35 each have a normal setting with liquid flowing through the connection designated as “a”. Diverter valve 17, when set for normal mode, allows liquid to flow only from main 20 to softener tank 19. Diverter valve 35, when set for normal mode, allows water to flow only from softener tank 19 to connector 40.

When linkage 14 sets valves 17 and 35 in regeneration mode, the “a” connection in each valve is shut, and the dotted line connections are opened (“b” state). Thus, for valve 17 when in regeneration mode, liquid from pipe 46 is directed to softener tank 19 and liquid from main 20 is directed to pipe 55. When valve 35 is in regeneration mode, the liquid from softener tank 19 is directed to pipe 38.

During regeneration, the water in main 20 is directed by valve 17 to pipe 55 and through brine tank 43 where salt is dissolved in the stream of water to form a brine solution. The resulting brine solution is directed by pipe 46 and diverter valve 17 to softener tank 19. The brine solution flows through softener tank 19 picking up divalent ions such as calcium adsorbed on the resin particles. Valve 35 then directs the brine solution with the calcium ions to brine tank 43 through a third diverter valve 54.

Conventionally, after most of the hardness ions have been removed from softener tank 19, valve 17 is returned to the “a” state, but valve 35 is kept in the “b” state. Fresh water from main 20 flowing through tank 19 flushes brine solution from tank 19. Early in the flushing phase, diverter valve 54 directs the solution from softener tank 19 to brine tank 43.

A control element 57 controls diverter valve 54. At some point during the flush cycle, control element 57 directs flow of the flushing water from brine tank 43 to the drain. Control element 57 can, for example, change the destination of the flushing water based on a preprogrammed time interval based on initiation of regeneration signaled by the position of linkage 14. More often though, control element 57 monitors the salinity of the liquid flowing in pipe 38 with samples provided by pipe 60. When salinity falls below a selected concentration, the flushing water can safely be diverted to the drain without causing excessive salinity in the drain water. This level may be driven as much by the environmental considerations as anything.

During such a regeneration cycle, the brine solution in brine tank 43 accumulates the divalent hardness ions that adsorb on the resin particles in softener tank 19. These hardness ions should be removed from the brine solution in brine tank 43 from softener tank 19 to allow the regeneration cycle to properly remove the hardness ions from the resin particles.

System 10 includes a recovery system that treats the brine solution in brine tank 43 to remove hardness such as calcium ions. The recovery system includes a pump 51 supplying the brine in the brine tank 43 to an NF membrane element 25. The NF membrane element 25 has an upstream side and a downstream side. The liquid on the downstream side is provided to pipe 28, and forms a permeate stream having a reduced concentration of the hardness ions such as divalent calcium ions. The permeate stream is returned to brine tank 43 through pipe 28. The reduced quantity of hardness ions in the permeate stream in pipe 28 results from the brine solution having been forced through the NF membrane element 25.

The liquid that does not pass, i.e., cannot be forced, through the NF membrane element 25 is the concentrate stream available at the upstream side of NF membrane element 25. The concentrate stream containing most if not all the hardness ions and possibly a small amount of brine, is directed to a throttling valve 31 and to a drain or septic tank. Throttling valve 31 creates back pressure at the upstream side of NF membrane element 25 necessary force liquid throught the NF membrane, and may comprise an orifice or other pressure-dropping device. Throttling valve 31 must maintain the pressure on the upstream side of NF membrane element 25 higher than in brine tank 43. The pressure drop across NF membrane element then equals approximately atmospheric pressure, assuming the brine tank 43 is not sealed.

Preferred embodiments may include pressure gauges and flow meters to monitor performance.

Preferably, the NF membrane element 25 has a spiral-wound configuration, although other configurations are possible, such as capillary fiber, tubular, or plate and frame. The following examples, without limitation, are types of NF membranes that are acceptable for use in the present invention, although their manufacturers may nor may not have their products evaluated for this application: a spiral wound NF-270 membrane, made by Dow Filmtec; a spiral-wound XN45 membrane, by TriSep Corp.; a spiral-wound SR2 membrane, by Koch Membrane Systems; a spiral-wound NF membrane using a special polymer, by Hydranautics; a spiral-wound NF membrane using a special polymer, by GE Osmonics; and a capillary fiber NF50 membrane, by Norit X-Flow.

Generally, a suitable NF membrane element 25 has a minimum of approximately 90% multivalent salts rejection and a maximum of approximately 20% monovalent salts rejection.

If the concentration of the brine solution in tank 43 is maintained above approximately 10%, pH adjustment is usually unnecessary. NF membrane element 25 can remove hardness ions from unmodified brine solution in brine tank 43. The term “unmodified” in this context refers to brine solution that has not been subjected to pH adjustment or other chemical treatment before passing to NF membrane element 25. This concentration of the brine solution can be maintained in a number of ways.

1. A process for regenerating a water softening system, said process of the type that removes multivalent ions from water, the water softening system including a softening tank through which the water to be softened passes from an upstream to a downstream end; a brine tank for holding a monovalent regenerating brine solution; a first diverter valve connected between the brine tank and the upstream end of the softening tank; a nanofilter, having upstream and downstream sides, for passing monovalent ions to the downstream side and retaining multivalent ions on the upstream side; a second diverter valve connecting between the downstream end of the softening tank and selectively to the upstream side of the brine tank; and, a connection between the downstream side of the nanofilter and the brine tank, said process comprising the steps of:
a) operating the first diverter valve to pass brine solution from the brine tank through the softening tank of the water softening system;
b) operating the second diverter valve to direct liquid from the downstream end of the softening tank to the brine tank;
c) directing unmodified liquid from the brine tank to the nanofilter;
d) directing the liquid on the downstream side of the nanofilter to the brine tank; and,
e) directing the liquid on the upstream side of the nanofilter to a drain.

2. The process of claim 1, wherein the water softening system includes a pump receiving brine solution from the brine tank and supplying brine solution to the nanofilter, and including the step of powering the pump concurrently with operating the second diverter valve.

3. The process of claim 2, wherein the water softening system includes a third diverter valve receiving the brine solution from the second diverter valve, and the process includes the step of directing liquid from the second diverter valve away from the brine tank responsive to a predetermined condition.

4. The process of claim 2 wherein the water softening system includes a third diverter valve receiving the brine solution from the second diverter valve, and the process includes the steps of
a) testing the salinity concentration of the liquid from the downstream end of the softening tank; and
b) responsive to said salinity concentration above a predetermined level, directing the liquid from the second diverter valve to the brine tank, and responsive to said salinity concentration below the predetermined level directing the liquid from the second diverter valve away from the brine tank.

5. The process of claim 2 wherein the water softening system includes a third diverter valve receiving the brine solution from the second diverter valve, and the process includes the steps of
a) timing from the start of the operating step for the second valve; and
b) responsive to said timing exceeding a predetermined time, directing fluid from the second diverter valve away from the brine tank.

6. The process of claim 2, including the step of directing the fluid from the brine tank, unmodified, to the nanofilter having a minimum of approximately 90% multivalent salts rejection and a maximum of approximately 20% monovalent salts rejection.

7. The process of claim 6, wherein the water softening system includes a throttling valve connected to the upstream side of the nanofilter, and including the step of maintaining a higher pressure on the upstream side of the nanofilter than in the brine tank.

8. The process of claim 2, wherein the water softening system includes a throttling valve connected to the upstream side of the nanofilter, and including the step of maintaining a higher pressure on the upstream side of the nanofilter than in the brine tank.

9. The process of claim 1, including the step of maintaining the concentration of the brine in the brine tank above approximately 10%.

10. A water softening system of the type that removes multivalent ions from water, said system including
a) a softening tank through which water to be softened passes from an upstream to a downstream end;
b) a brine tank for holding a regenerating brine solution;
c) a first diverter valve connected between the brine tank and the upstream end of the softening tank; and
d) a second diverter valve receiving fluid from the downstream end of the softening tank and supplying fluid selectively to either a plumbing connector or the upstream side of the brine tank;
wherein the improvement comprises apparatus for reducing the flow of brine to a drain during a regeneration cycle which removes the multivalent ions in the softening tank, said apparatus comprising
e) a filter having upstream and downstream sides, for passing monovalent ions to the downstream side and retaining multivalent ions on the upstream side;
f) a pump pumping fluid from the brine tank to the upstream side of the filter;
g) a filter-brine tank connection between the downstream side of the filter and the brine tank;
h) a filter-drain connection between the upstream side of the filter and a drain;
i) a third diverter valve receiving liquid from the downstream end of the softening tank and directing softening tank liquid to the brine tank responsive to a control element signal; and
j) a control element providing during the regeneration cycle, the control element signal to the third diverter valve.

11. The apparatus of claim 10, wherein the filter-drain connection comprises a throttling valve.

12. The apparatus of claim 10, including a softener tank-control element connection, and wherein the control element removes the control element signal to the third diverter valve responsive to a preselected condition of the liquid from the downstream end of the softening tank.

13. The apparatus of claim 12, wherein the softener tank-control element connection comprises a pipe.

14. The apparatus of claim 12, wherein the preselected condition of the liquid the from the downstream end of the softening tank is a preselected salinity concentration.

15. The apparatus of claim 14 wherein the filter is a nanofilter.

16. The apparatus of claim 10 wherein the filter is a nanofilter.

17. The process of claim 1, including the step of maintaining the concentration of the brine in the brine tank above a predetermined concentration.
